(19) United States
(12) Patent Application Publication
(10) Pub. No.: US 2026/0239440 A1
(43) Pub. Date: Aug. 13, 2026

(54) NETWORK NODE, USER EQUIPMENT AND METHODS PERFORMED THEREIN

(71) Applicant: Telefonaktiebolaget LM Ericsson (publ), Stockholm (SE)

(72) Inventors: Sakib BIN REDHWAN, Linköping (SE); Ali PARICHEHREHTEROUJENI, Linköping (SE); Johan RUNE, Lidingö (SE); Angelo CENTONZA, Granada (ES)

(21) Appl. No.: 19/155,647

(22) PCT Filed: Feb. 15, 2024
(86) PCT No.: PCT/SE2024/050149

§ 371 Date: Aug. 12, 2025

Related U.S. Application Data
(60) Provisional application No. 63/485,262, filed on Feb. 16, 2023.

(51) Int. Cl. H04W 74/0833; H04W 88/06

(52) U.S. Cl. CPC H04W 74/0833; H04W 88/06

(57) ABSTRACT

Embodiments herein provide a method performed by a UE for handling communication in a communication network. The UE provides to a network node, a RA report of a RA procedure over a first RAT for the UE, and assistance information indicating how to route the RA report between a second radio network node of a second RAT collecting the RA report and a first radio network node of the first RAT controlling a cell where the RA procedure that is logged in the RA report was performed.

### TECHNICAL FIELD

Embodiments herein relate to a network node, a user equipment (UE) and methods performed therein regarding communication. Furthermore, a computer program and a computer readable storage medium are also provided herein. In particular, embodiments herein relate to handling reports in a communication network.

### BACKGROUND

In a typical communication network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g. a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases (Rel), such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

In most cases, uplink transmissions in cellular network are controlled by the network, i.e., UEs only transmit uplink data in dedicated slots allocated by the network and the risk of collision between uplink transmission from different UEs are minimal. However, at initial access from idle/inactive state, there is no connection to the network and UEs do not have any dedicated resources. Furthermore, there is no means to the network to estimate the transmission time of the UE based on previous transmission. Hence, it is common to have collisions between uplink transmissions from different UEs.

Random access (RA) procedure is designed to solve this problem. In the random access procedure, UEs send an initial preamble, such as a random access channel (RACH) preamble, to the network and exchange messages with the aim to resolve potential contention resolution, timing information, uplink grant etc.

Further use cases of random-access procedure include:
1) Handover, when synchronization is required in a new cell.
2) Reestablishment of uplink synchronization to the current cell; this may happen due to long inactivity in the uplink.
3) Requesting uplink scheduling grant if that has not been provided to the UE.
4) Requesting the transmission of the non-broadcasted system information blocks (SIB).

There are two types of random-access procedures: Contention free random access (CFRA), where the UEs are provided with dedicated preambles; and Contention based random access (CBRA), where UEs carry out random access based on some common preambles.

Moreover, based on the message/signalling exchange between network and UEs, both CBRA and CFRA can be further divided into two procedures:

### 4-Step RA.

The following exchange between UE and network takes place in a 4-step RA shown in FIG. 1.

Step-1: Device transmits a preamble, also known as physical random access channel (PRACH). The preamble is designed for low-complexity reception despite the lack of a timing control.

Step-2: Network transmits with a random-access response (RAR) indicating the reception of the preamble and providing time-alignment command based on the timing of the received preambles.

Step-3 and 4: UE and network exchange message 3 and message 4 with the aim of potential collision resolution.

### 2-Step RA.

In a 2-step RA, the procedure is simplified: PRACH and message 3 of the 4-step RA is combined into one message; namely, message-A and RAR and message-4 is combined into another message; namely, message-B. The aim of this procedure is to enable faster access see FIG. 2.

Multi-radio dual connectivity (MR-DC) is a generalization of the E-UTRA dual connectivity where a multiple Tx/Rx capable UE may be configured to utilize resources provided by two different nodes connected via non-ideal backhaul, one providing NR access and other providing either E-UTRA or NR access. One node act as the Master node (MN) and other node or nodes act as the Secondary nodes (SN). Further details to be found in 37.340; Evolved Universal Terrestrial Radio Access (E-UTRA) and NR; Multi-connectivity; Stage 2-V17.3.0, 3GPP.

E-UTRAN supports MR-DC via E-UTRA-NR Dual connectivity (EN-DC), in which a UE is connected to one eNB that acts as MN and one en-gNB that acts as a SN. The eNB is connected to the EPC via the S1 interface and to the en-gNB via the X2 interface.

FIG. 3 shows a Control plane connectivity for EN-DC.

From a radio protocol point of view, the control plane for EN-DC is shown in FIG. 4.

FIG. 4 shows a Control plane architecture for EN-DC.

Thus, all UE control plane signals are transmitted via E-UTRAN eNB. There is no control plane connection between gNB and the EPC. The overall architecture for EN-DC shows that an en-gNB is connected to one eNB via X2, thus it does not have multiple X2 connections to different eNBs, shown in FIG. 5. FIG. 5 shows an EN-DC overall architecture.

### RA Report in NR.

A basic form of RACH report from the UE was introduced in LTE. However, in NR Rel-16, an extensive report is collected and analyzed in network nodes for optimization purpose. And an extract from 38.331; NR; Radio Resource Control (RRC); Protocol specification; V-17.3.0, 3GPP is provided below. A list of RA-Reports is collected by the UE and provided to network upon network request. Details of the collection mechanism can be found in 38.331; NR; Radio Resource Control (RRC); Protocol specification; V-17.3.0, 3GPP.

RA-ReportList-r16 ::= SEQUENCE (SIZE (1..maxRAReport-r16)) OF RA-Report-
r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | PCI-ARFCN-NR-r16 |

},

| | |
|---|---|
| ra-InformationCommon-r16 | RA-InformationCommon-r16 |

OPTIONAL,

| | |
|---|---|
| raPurpose-r16 | ENUMERATED {accessRelated, |

beamFailureRecovery, reconfigurationWithSync, ulUnSynchronized,
schedulingRequestFailure, noPUCCHResourceAvailable, requestForOtherSI,
msg3RequestForOtherSI-r17, spare8, spare7, spare6, spare5, spare4, spare3,

spare2, spare1},

```
  ...,
  [[
```

| | |
|---|---|
| spCellID-r17 | CGI-Info-Logging-r16 |

OPTIONAL
]]
}

### SUMMARY

As part of developing embodiments herein one or more problems have been identified. In MR-DC, the RACH report collection mechanism is defined for MN only. Thus, an UE may collect a RACH report for both MN and SN, but only MN can fetch the report. Moreover, the RACH report list may contain RACH performed by the UE at different cells. It is up to the collecting node to distribute the report to proper nodes.

In Rel-18 self-organizing networks (SONs) work item (WI), ongoing works regarding RACH optimization are included. One such discussion is about improving NR RACH report in EN-DC. Under this discussion it was agreed that the MN, such as an EUTRAN eNB, would be able to collect RACH report of SN, such as a NR gNB, from the UE. Furthermore, in R2-2211164, Reply LS on SN RACH report status in R17, 3GPP TSG RAN WG #120 it was proposed that the UE should report the NR primary secondary cell (PSCell) identity outside of the RACH report to help forwarding of the report.

In EN-DC, a UE may perform a random-access procedure in the SN, i.e., a NR node, and store an RA-Report. Such RA-report, stored by the UE, is encoded in NR format and contains NR cell information only. Upon performing handover(s), or cell re-selections, after having spent time in RRC_INACTIVE or RRC_IDLE state, the UE may connect to a different EUTRAN cell. If the new cell collects the RACH report from the UE, it will not be able to read the NR cell information and forward the NR RA-report, initially stored by the UE, to the proper NR node.

Namely, the new eNB serving the UE needs to know the cell identity of the cell where the access that generated the RA report in order to forward the RA report to the NR node serving that cell. This allows the NR node to analyze the report and to deduce from it the information that may be useful to optimize RACH configuration. The proposal in R2-2211164, Reply LS on SN RACH report status in R17, 3GPP TSG RAN WG #120 to include the PSCell information outside of the NR RA report is not sufficient since if the NR RA report is collected later in a different EUTRAN node, the collecting node may not have an X2 connection with the NR RAN node controlling the cell in which the random access procedure logged in the RA report was performed, and the collecting node will thus not be able to forward the RA report. Furthermore, the EUTRAN node collecting from the UE the NR RA report, may be connected to a different mobility management entity (MME) as compared to the eNB acting as MN node for the EN-DC connection in which the NR node associated to the NR RA report was acting as SN node. In such case an Xn connection between the new serving RAN node and the previous NR SN and/or the previous E-UTRA MN, may not be available. Hence, the RA report cannot be forwarded to the NR node where RACH access occurred.

The proposal in R2-2211164, Reply LS on SN RACH report status in R17, 3GPP TSG RAN WG #120 is also insufficient because the UE is not mandated to read the NR cell global identity (CGI) of the PSCell. Hence reporting PSCell information outside of the RA Report may be not possible or it might be limited to partial PSCell information.

Another problem occurs in the case of a UE initially in NR single connectivity with a first gNB, that performed RA to the NR cell and logs the respective NR RA report. The UE then reselected an EUTRAN cell served by an eNB which has no Xn connectivity towards the first gNB associated to the NR RA report. If the first gNB did not fetch the NR RA report before the UE reselected the EUTRA cell, the eNB is not able to forward the NR RA report to the first gNB.

An object herein is to provide a mechanism to handle communication in an efficient manner in the communication network.

According to an aspect the object is achieved, according to embodiments herein, by providing a method performed by a UE for handling communication in a communication network. The UE may obtain RA parameters of a RA procedure, and may receive a request from a second radio network node, such as an LTE eNB, of a second RAT, such as LTE, to provide a RA report. The UE provides, e.g., transmits, to a network node a RA report of a RA procedure over a first RAT for the UE, and assistance information indicating how to route the RA report between a second radio network node of a second RAT collecting the RA report and a first radio network node of the first RAT controlling a cell where the RA procedure that is logged in the RA report was performed.

According to another aspect the object is achieved, according to embodiments herein, by providing a method performed by a network node, such as a second radio network node, or a first/second network node, for handling communication in a communication network. The network node obtains a RA report of a RA procedure of a first RAT for a UE, and assistance information indicating how to route the RA report between a second radio network node of a second RAT collecting the RA report and a first radio network node controlling a cell where the RA procedure that is logged in the RA report was performed. The second radio network node forwards the RA report based on the assistance information.

According to an aspect the object is achieved, according to embodiments herein, by providing a network node and a UE configured to perform the methods herein, respectively.

Thus, according to an aspect the object is achieved, according to embodiments herein, by providing a UE for handling communication in a communication network. The UE is configured to provide, e.g., transmit, to a network node, a RA report of a RA procedure over a first RAT for the UE, and also to provide assistance information indicating how to route the RA report between a second radio network node of a second RAT collecting the RA report and a first radio network node of the first RAT controlling a cell where the RA procedure that is logged in the RA report was performed.

According to another aspect the object is achieved, according to embodiments herein, by providing a network node, such as a second radio network node, or a first/second network node for handling communication in a communication network. The network node is configured to obtain a RA report of a RA procedure of a first RAT for a UE, and assistance information indicating how to route the RA report between a second radio network node of a second RAT collecting the RA report and a first radio network node controlling a cell where the RA procedure that is logged in the RA report was performed. The network node is further configured to forward the RA report based on the assistance information.

It is furthermore provided herein a computer program product comprising instructions, which, when executed on at least one processor, cause the at least one processor to carry out any of the methods herein, as performed by the network node and the UE, respectively. It is additionally provided herein a computer-readable storage medium, having stored thereon a computer program product comprising instructions which, when executed on at least one processor, cause the at least one processor to carry out any of the methods herein, as performed by the network node and the UE, respectively.

Embodiments herein disclose procedures such as a method to be performed by a UE operating in dual connectivity to include one or more identifiers that can lead to the identification of a first network node, such as an MN, of an access network type, such as NR or LTE, and that enable the forwarding of information to the first or another first network node (SN) connected to a third network node.

In one embodiment such assistance information may be included in an information element (IE) for transporting NR RA reports, henceforth referred to as an “NR RA report container” where the NR RA report container includes a list of first reports, e.g. RA-ReportList, where the first report, e.g. NR RA-Report, contains a report of a random-access procedure performed in a first access network type, e.g. NR. The method involves a UE performing one or more of the following:
Logging random access procedure related information in a first report such as a RA Report, where the random-access was performed in a cell belonging to a first network node, e.g. supporting NR. The UE may log a list of first reports, e.g. RA-ReportList, that may comprise n such first reports.
   Including the cell information of the second network node, e.g. MN, belonging to a second access network type, e.g. LTE as part of the first report, e.g. RA Report.
A first indication may be transmitted to the network regarding capability of including first report in the UEInformationReponse message.
A second indication may be transmitted to the network regarding capability of including additional or assistance information as an item in a list in the UEInformationReponse message.
A request may be received from a second network node, e.g. LTE eNB, of the second access network type, e.g. LTE, to provide the first report.
   The UE may receive an explicit request to provide the first report.
   The UE may not receive an explicit request to provide the first report. The UE may receive a request to provide random-access related information belonging to the second access network type.
The list of first reports, e.g. RA-ReportList, may be included in the NR RA report container and for each first report, e.g. RA Report, of the list, the assistance information needed to route the RA Reports to the first network node belonging to a first/second RAT may be included as an item in a list in the UEInformationResponse message. Thus, for each first report in the list of first reports, the RA report container may have an item with such assistance information in the list.
   In one embodiment, the assistance information used to identify the MN, third radio network node, may consist of the CGI of the primary cell (PCell) served by the MN. The PCell CGI includes the Global Node ID of the MN, which can be used to identify the MN. With this information, the RAN node, such as the second radio network node, receiving the RA Reports (from the UE) may be able to forward the RA Reports to the CN. The CN may be able to forward the RA Reports to the MN connected to the SN, first radio network node, where the one or more reports were generated. The MN may then forward such reports to the one or more SN node connected to it where the reports were generated.
   In another embodiment, the assistance information used to identify the MN may consist of the CGI and tracking area identifier (TAI) of the PCell served by the MN and serving the UE at the time one or more RA Reports was logged. The PCell CGI includes the Global Node ID of the MN, which can be used to identify the MN, while the TAI of the Pcell can be used to route messages containing the RA Reports to the MN via one or more nodes in the core network. With this information, the RAN node receiving the RA Reports may be able to forward the RA Reports to the CN. The CN may be able to forward the RA Reports to the MN connected to the SN where the one or more reports were generated. Such forwarding may potentially happen via other CN nodes connected to the MN. The MN may then forward such reports to the one or more SN node connected to it where the reports were generated.
   In another embodiment, the assistance information used to identify the MN may consist of the CGI of the PSCell served by the SN where the RACH access generating the one or more RA Report logged by the UE occurred. The PSCell CGI includes the Global Node ID of the SN, also referred to as spCell-ID or PScell-ID. This information may be signalled to the CN together with the RA Report. The CN may identify the MN to which the RA Report needs to be forwarded because the CN is aware that the SN identified by the global node ID in the PSCell CGI is connected to the target MN. With this information the RAN node receiving the RA Reports may be able to forward the RA Reports to the CN. The CN may be able to forward the RA Reports to the MN connected to the SN where the one or more reports were generated because the CN can derive the SN global node ID from the PSCell CGI and the CN knows that the SN where the RA Reports need to be forwarded is connected to a specific node, i.e. the MN, hence the CN can derive the identity of the MN where the RA Reports need to be forwarded. The CN may therefore forward the RA reports to the MN and the MN may then forward such reports to the one or more SN node connected to it where the reports were generated.
   In another embodiment, the assistance information used to identify the MN may consist of the CGI and TAI of the PCell served by the MN. Additionally, the information includes the physical cell identity (PCI) and or CGI of the PSCell served by the SN where the RACH access generating the one or more RA Report logged by the UE occurred. With this information, the RAN node receiving the RA Reports may be able to forward the RA Reports to the CN. The CN may be able to forward the RA Reports to the MN connected to the SN where the one or more reports were generated. Such forwarding may potentially happen via other CN nodes connected to the MN. The MN may then forward such reports to the one or more SN node connected to it where the reports were generated.
   The above is because the TAI of the PCell can be used by the CN to route messages containing the RA Reports to the CN node connected to the MN. The PCell CGI includes the Global Node ID of the MN, which can be used by the CN node receiving the information to identify the MN. While The PSCell PCI and/or CGI may be used by the MN to forward the received RA Reports to the appropriate SN. With this information the MN can identify the SN to which the corresponding RA Reports need to be forwarded because the MN knows the cells served by such SN and their PCI/CGI. Assuming that the PCI of the PSCell is not reused in the neighbourhood of the PCell, the MN can identify the SN that serves the cell identified by the PSCell PCI and forward the RA Report there. Alternatively or additionally the PSCell CGI can be used for such purpose.
Embodiments herein may, for example, propose a method performed by a network node in a network (i.e. a network node, e.g. an eNB, an MME or similar)—
A first indication may be received from the UE regarding capability of including list of first report in the UEInformationReponse message.
A second indication may be received from the UE regarding capability of including the assistance information as an item in a list in the UEInformationReponse message.
The UE may be requested to transmit to provide a RA report or a list of first reports.
   In an example, the network node may send an explicit request to provide the list of first report.
   In another example, the network node may not send an explicit request to provide the list of first report. The network sends a request to provide a third report containing random-access related information belonging to the second access network type.
   In another example, the network node may send a request to the UE to provide the list of first report, if it is available (i.e. an opportunistic request)
The NR RA report container may be received from the UE as part of the UEInformationResponse message.
The node(s) for the first report(s) may be identified, based on the assistance information in the NR RA report container, and may be forwarded.
   The forwarding may involve other network nodes belonging to core network of different technologies.
The NR RA report container may be transmitted to the identified network node.

As an example, when a UE has logged a RA report of a random access procedure performed in an NR PSCell controlled by an NR SN, such as a first radio network node, when the UE was connected in EN-DC mode, and may be requested by another LTE eNB, such as a second radio network node, to send the RA report, the UE sends, and the eNB (which requested the RA report) receives, assistance information outside of the NR SN RA report in order to enable propagation/routing of the RA report between the LTE eNB collecting the RA report and the NR gNB controlling the cell where the random access procedure that is logged in the RA report was performed. The solution further proposes optional capability indicator sent from the UE to an eNB to enable the eNB to take an informed decision regarding the availability of NR RA report and whether to request it.

Thus, it is herein disclosed a solution to handle communication in an efficient manner in the communication network.

### BRIEF DESCRIPTION OF THE DRAWINGS

Embodiments will now be described in more detail in relation to the enclosed drawings, in which:

FIGS. 1,2,3,4,5 are schematic overviews depicting prior art;

FIG. 6 shows an overview depicting a communication network according to embodiments herein;

FIG. 7 shows a combined signalling scheme and flowchart depicting embodiments herein;

FIG. 8 shows a flowchart depicting a method performed by a UE according to embodiments herein:

FIG. 9 shows a flowchart depicting a method performed by a network node according to embodiments herein;

FIG. 10 shows a schematic signalling flow according to some embodiments herein;

FIG. 11 shows a schematic signalling flow according to some embodiments herein;

FIG. 12 shows a schematic signalling flow according to some embodiments herein;

FIG. 13 shows a schematic signalling flow according to some embodiments herein;

FIG. 14 shows a schematic signalling flow according to some embodiments herein;

FIG. 15 shows s block diagram depicting embodiments of a UE according to embodiments herein;

FIG. 16 shows s block diagram depicting embodiments of a network node according to embodiments herein;

FIG. 17 schematically illustrates a telecommunication network connected via an intermediate network to a host computer;

FIG. 18 is a generalized block diagram of a host computer communicating via a base station with a user equipment over a partially wireless connection; and

FIGS. 19,20,21,22 are flowcharts illustrating methods implemented in a communication system including a host computer, a base station and a user equipment.

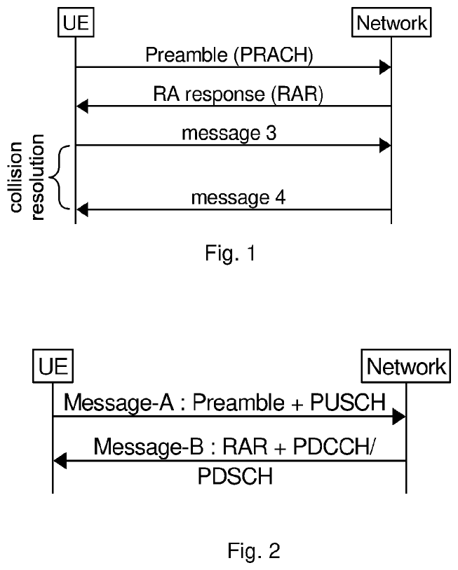

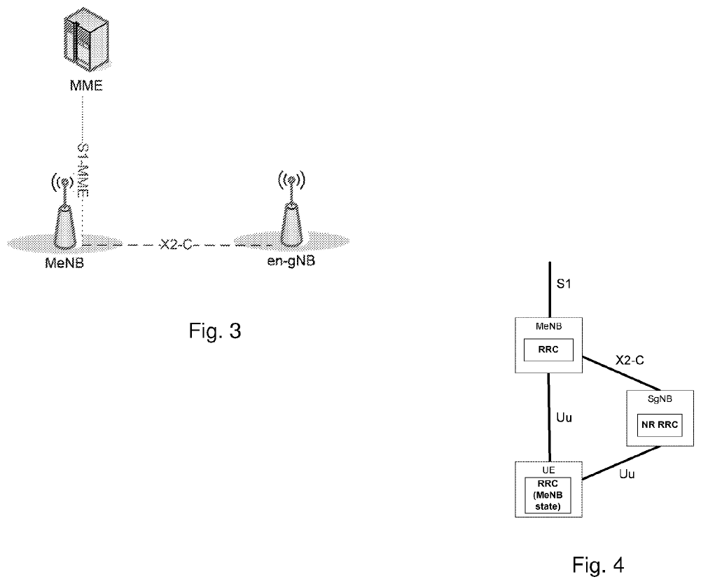

### DETAILED DESCRIPTION

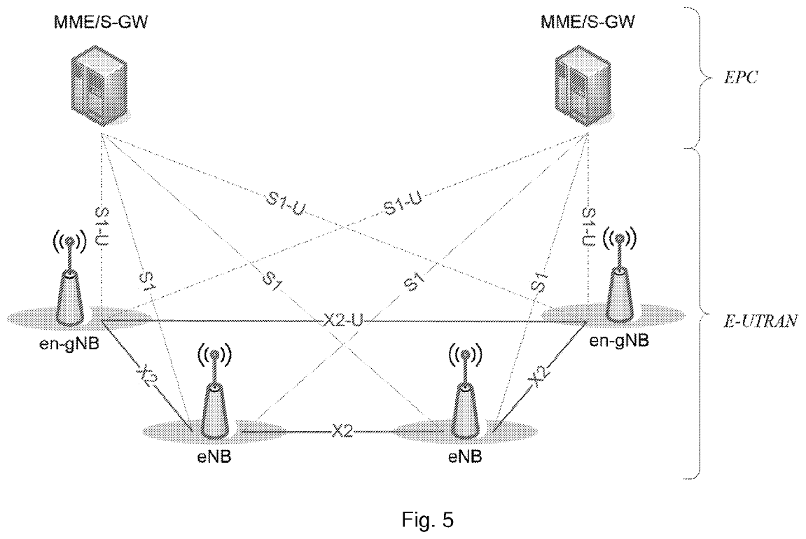

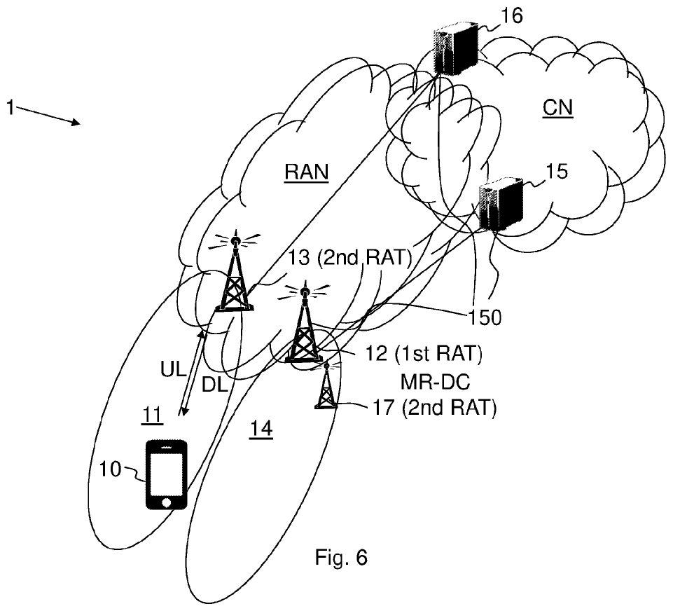

Embodiments herein relate to communication networks in general. FIG. 6 is a schematic overview depicting a communication network 1. The communication network 1 comprises one or more RANs and one or more CNs. The communication network 1 may use one or a number of different technologies. Embodiments herein relate to recent technology trends that are of particular interest in a NR context, however, embodiments are also applicable in further development of existing wireless communications systems such as e.g. Wi-Fi, LTE, LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

In the communication network 1, a UE 10 exemplified herein as a wireless device such as a mobile station, a non-access point (non-AP) station (STA), a STA and/or a wireless terminal, is comprised communicating via e.g. one or more Access Networks (AN), e.g. RAN, to one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The communication network 1 comprises a first radio network node 12 or just radio network node, providing radio coverage over a geographical area, a first service area 11 or first cell, of a first RAT, such as NR, LTE, or similar. The first radio network node 12 may be a transmission and reception point such as an PScell node access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point, a en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node. or any other network unit or node capable of communicating with a wireless device within the area served by the radio network node depending e.g. on the first radio access technology and terminology used. The first radio network node 12 may be referred to as a serving radio network node wherein the service area may be referred to as a serving cell, and the serving network node communicates with the UE 10 in form of DL transmissions to the UE and UL transmissions from the UE 10. It should be noted that a service area may be denoted as cell, beam, beam group or similar to define an area of radio coverage.

The communication network 1 comprises a second radio network node 13 or another radio network node, providing radio coverage over a geographical area, a second service area 14 or second cell, of a second RAT, such as NR, LTE, or similar. The second radio network node 13 may be a transmission and reception point such as an access node, an access controller, a base station, e.g. a radio base station such as a gNB, an eNB, eNode B, a NodeB, a base transceiver station, a radio remote unit, an Access Point Base Station, a base station router, a WLAN access point or an AP STA, a transmission arrangement of a radio base station, a stand-alone access point, a en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node. or any other network unit or node capable of communicating with a wireless device within the area served by the radio network node depending e.g. on the first radio access technology and terminology used. The second radio network node 13 may be referred to as a radio network node of the second RAT wherein the service area may be referred to as a serving cell, and the second radio network node communicates with the UE 10 in form of DL transmissions to the UE 10 and UL transmissions from the UE 10. It should be noted that a service area may be denoted as cell, beam, beam group or similar to define an area of radio coverage. The first RAT is different than the second RAT.

The communication network may comprise one or more network nodes such as a first network node 15 and a second network node 16 of same or different networks. The first and/or second network nodes may be core network nodes such as MMEs or Access and Mobility Management Functions (AMF). The second radio network node 13, the first network node 15 and the second network node 16 are examples of a network node 150 according to embodiments herein.

The network node 150 may be a RAN node, an operations, administration and maintenance (OAM), a Core Network node, a Service management and orchestration (SMO), a Network Management System (NMS), a Non-Real Time RAN Intelligent Controller (Non-RT RIC), a Real-Time RAN Intelligent Controller (RT-RIC), a gNB, eNB, en-gNB, ng-eNB, gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, O-CU, O-CU-CP, O-CU-UP, O-DU, O-RU, O-eNB, a Cloud-based network function, a Cloud-based centralized training node.

The first radio network node 12 may be a 1^{st} RAT node, e.g. NR, of an EN-DC scenario wherein a third radio network node 17 may be a second RAT node, e.g. LTE.

The UE 10 may collect RA parameters during a RA procedure of the first radio network node 12. The UE 10 may then transmit a RA report to the second radio network node 13, and assistance information indicating how to route the RA report between the second radio network node 13 of the second RAT collecting the RA report and the first radio network node 12 of the first RAT controlling the cell where the RA procedure that is logged in the RA report was performed. Forwarding of the RA report is then based on the assistance information.

This enables the network node 150 of the second RAT fetching the RA report of the first RAT to correctly identify the network node which was acting as the UE's MN while the RA report was created, containing information about a random access procedure performed in, for example, an NR cell controlled by an NR node, e.g. a gNB or an en-gNB, acting as the UE's SN. The network node 150 of the second RAT fetching the RA report may then, for example, forward the RA report to the identified network node of the second RAT, which network node was acting as the UE's MN when the RA report was created, and this network node of the second RAT may in turn identify the NR, which was acting as the UE's SN, node and forward the report to the NR node for analysis.
LTE and EUTRAN has been used as inter-exchangeable. The second access network type refers to LTE.
The first access network type refers to NR.
The second and third network node may be the same node.
The term RA report is used frequently in the solution description. In this context “RA report” refers to a report which contains information about a random access procedure performed in an NR cell, and which is adapted for transmission in an NR cell, i.e., to a gNB or an en-gNB, In ASN.1 the RA report is the RA-Report-r16 IE. A corresponding report containing information about a random access procedure performed in an LTE cell, which is adapted for transmission in an LTE cell, is referred to as a RACH report. In ASN.1 the RACH report is the RACH-Report-r16 IE.

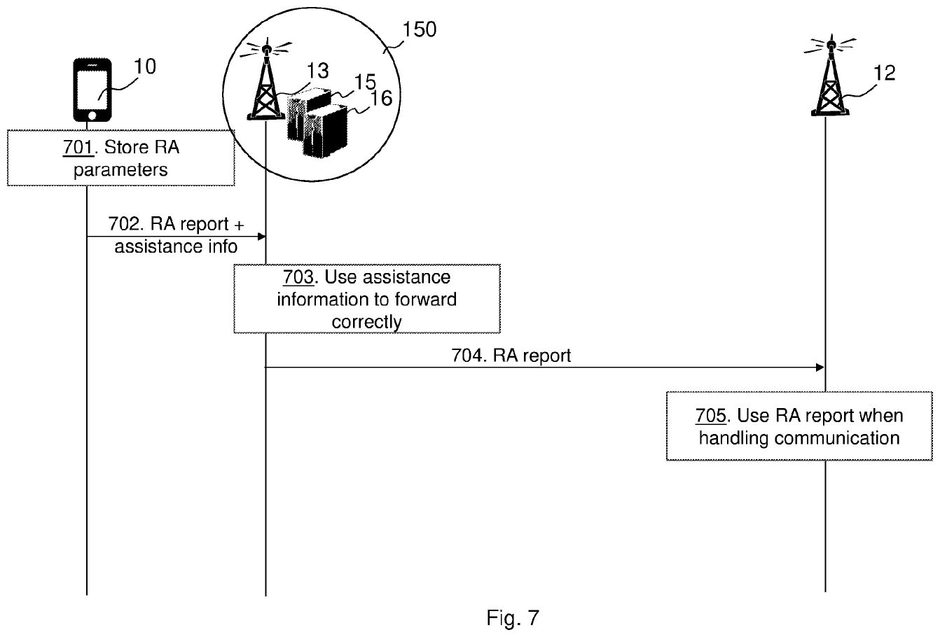

FIG. 7 is a combined signalling scheme and flowchart depicting embodiments herein.

Action 701. The UE 10 may perform RA and may thereby obtain RA parameters during the RA procedure, and include assistance information for the RA report. The UE 10 may store one or more RA reports with the RA parameters in a list of RA reports with a respective assistance information.

Action 702. The UE 10 sends the RA report and the assistance information, for example, in a RA report container.

Action 703. The network node 150, such as the second radio network node 13, receives the RA report and the assistance information, and may use the assistance information to determine how to process and forward the RA report to a network node.

Action 704. The network node 150 forwards the RA report based on the assistance information. For example, the network node 150 may forward the RA report to the first radio network node 12, or a third network node associated with the first radio network node 12, based on the assistance information.

Action 705. The first radio network node 12 may use the RA report when handling communication, for example, update or modify, RACH related configuration.

In this disclosure a term node is used which can be a network node (radio network node) or a user equipment (UE).

Examples of network nodes or radio network nodes are NodeB, base station (BS), multi-standard radio (MSR) radio node such as MSR BS, eNodeB, gNodeB, master eNodeB (MeNB), secondary eNodeB (SeNB), location measurement unit (LMU), integrated access backhaul (IAB) node, network controller, radio network controller (RNC), base station controller (BSC), relay, donor node controlling relay, satellite node, non-terrestrial network (NTN) node, high altitude platform (HAPS) node, base transceiver station (BTS), Central Unit (e.g. in a gNB), Distributed Unit (e.g. in a gNB), Baseband Unit, Centralized Baseband, C-RAN, access point (AP), transmission points, transmission nodes, transmission reception point (TRP), RRU, RRH, nodes in distributed antenna system (DAS), core network node, e.g., Mobility Management Entity (MME), mobile switching center (MME) etc, operations and maintenance (O&M), OSS, SON, positioning server (e.g. LMF, E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, internet of things (IoT) capable device, tablet, mobile terminals, smart phone, laptop embedded equipment (LEE), laptop mounted equipment (LME), USB dongles etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are reference signal (RS) such as primary synchronization signal (PSS), secondary synchronization signal (SSS), CSI-RS, DMRS signals in SS/PBCH block (SSB), discovery reference signal (DRS), CRS, PRS etc. RS may be periodic e.g. RS occasion carrying one or more RSs may occur with certain periodicity e.g. 20 ms, 40 ms etc. The RS may also be aperiodic. Each SSB carries NR-PSS, NR-SSS and NR-physical broadcast channel (PBCH) in 4 successive symbols. One or multiple SSBs are transmit in one SSB burst which is repeated with certain periodicity e.g. 5 ms, 10 ms, 20 ms, 40 ms, 80 ms and 160 ms. The UE is configured with information about SSB on cells of certain carrier frequency by one or more SS/PBCH block measurement timing configuration (SMTC) configurations. The SMTC configuration comprises parameters such as SMTC periodicity, SMTC occasion length in time or duration, SMTC time offset with regards to reference time, e.g. serving cell's SFN, etc. Therefore, SMTC occasion may also occur with certain periodicity e.g. 5 ms, 10 ms, 20 ms, 40 ms, 80 ms and 160 ms. Examples of UL physical signals are reference signal such as SRS, DMRS etc. The term physical channel refers to any channel carrying higher layer information, e.g., data, control etc. Examples of physical channels are PBCH, NPBCH, PDCCH, PDSCH, sPUCCH, sPDSCH. sPUCCH. sPUSCH, MPDCCH, NPDCCH, NPDSCH, E-PDCCH, PUSCH, PUCCH, NPUSCH etc.

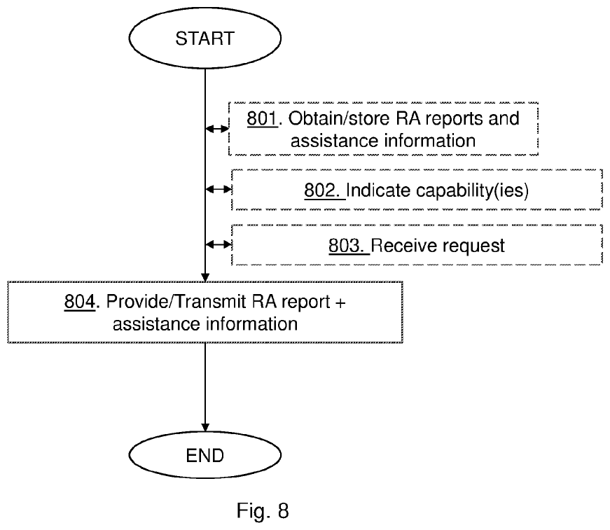

The method actions performed by the UE 10 for handling communication in the communication network 1 according to embodiments will now be described with reference to a flowchart depicted in FIG. 8. The actions do not have to be taken in the order stated below but may be taken in any suitable order. Dashed boxes indicate optional features.

Action 801. The UE 10 may store obtained one or more RA reports associated with one or more assistance information. The UE 10 may thus obtain RA parameters of a RA procedure and may store RA reports associated with assistance information. The UE may obtain one or more RA reports in a list of RA reports. The assistance information may comprise a CGI of a SPCell-ID, i.e., identity of a first radio network node being an PSCell network node, for each element of a list of RA reports. Thus, the assistance information may comprise the identity of the first radio network node 12, for (linked to) the received RA report.

Action 802. The UE 10 may indicate to the second radio network node 13 one or more capabilities comprising a capability of reporting RA reports and/or a capability to report the assistance information.

Action 803. The UE 10 may receive a request from the second radio network node 13 for reporting one or more RA reports. The UE 10 may receive a request from the second radio network node 13, such as an LTE eNB, of the second RAT, such as LTE, to provide a RA report.

Action 804. The UE 10 provides to a network node a RA report of a RA procedure over a first RAT for the UE 10, and assistance information indicating how to route the RA report between the second radio network node 13 of the second RAT collecting the RA report and the first radio network node 12 of the first RAT controlling the cell where the RA procedure that is logged in the RA report was performed. The assistance information indicating how to route the RA report may be defined by comprising a CGI and/or TAI of an SPCell identity for each element of a list of RA reports. Thus, the assistance information may comprise a CGI of a SPCell-ID for each element of a list of RA reports.

Hence, some embodiments may involve UE capability signalling and transmission of a NR RA report in LTE.

In one embodiment, the UE 10 may include a first indication to the network, such as the second network node 13, regarding capability of including the list of first report in the UEInformationReponse message.

In another embodiment, the UE 10 may include a second indication to the network, such as the second network node 13, regarding capability of including additional information as an item in a list in the UEInformationReponse message.

In another embodiment, the first and second indication may be combined onto a single indication. These embodiments are all related to the action 802 above.

### Assistance Information:

In an embodiment, the UE 10 may include the list of first reports (RA-ReportList) in the NR RA report container and for each first report (RA Report) of the list, include the assistance information needed to route the RA Reports to the first network node 12 belonging to a first access network type as an item in a list in the UEInformationResponse message. Thus, for each first report (RA Report) in the list of first reports (RA-ReportList), the RA report container has an item with such assistance information in the list. The assistance information indicating how to route the RA report may be defined by comprising a CGI of an SPCell identity for each element of a list of RA reports. The assistance information may be exemplified in the below embodiments.
   In one embodiment, the assistance information used to identify the MN may consist of the CGI of the PCell served by the MN. The PCell CGI includes the Global Node ID of the MN, which can be used to identify the MN. With this assistance information, the RAN node, such as the second radio network node 13, receiving the RA Reports (from the UE) may be able to forward the RA Reports to the CN. The CN may be able to forward the RA Reports to the MN connected to the SN where the one or more reports were generated. The MN may then forward such reports to the one or more SN node connected to it, where the reports were generated.
   In another embodiment, the assistance information used to identify the MN may consist of the CGI and TAI of the PCell served by the MN and serving the UE at the time one or more RA Reports was logged. The PCell CGI includes the Global Node ID of the MN, which can be used to identify the MN, while the TAI of the Pcell can be used to route messages containing the RA Reports to the MN via one or more nodes in the core network. With this assistance information, the RAN node receiving the RA Reports may be able to forward the RA Reports to the CN. The CN may be able to forward the RA Reports to the MN connected to the SN where the one or more reports were generated. Such forwarding may potentially happen via other CN nodes connected to the MN. The MN may then forward such reports to the one or more SN node connected to it where the reports were generated.
   In another embodiment, the assistance information used to identify the MN may consist of the CGI of the PSCell served by the SN where the RACH access generating the one or more RA Report logged by the UE occurred. The PSCell CGI includes the Global Node ID of the SN. This assistance information may be signalled to the CN together with the RA Report. The CN may identify the MN to which the RA Report needs to be forwarded because the CN is aware that the SN identified by the global node ID in the PSCell CGI is connected to the target MN. With this assistance information the RAN node, such as the second network node 13, receiving the RA Reports may be able to forward the RA Reports to the CN. The CN may be able to forward the RA Reports to the MN connected to the SN where the one or more reports were generated because the CN can derive the SN global node ID from the PSCell CGI and the CN knows that the SN where the RA Reports need to be forwarded is connected to a specific node, i.e. the MN, hence the CN can derive the identity of the MN where the RA Reports need to be forwarded. The CN may therefore forward the RA reports to the MN and the MN may then forward such reports to the one or more SN node connected to it where the reports were generated.
   In another embodiment, the assistance information used to identify the MN may consist of the CGI and TAI of the PCell served by the MN. Additionally, the assistance information includes the PCI and or CGI of the PSCell served by the SN where the RACH access generating the one or more RA Report logged by the UE occurred. With this assistance information, the RAN node, such as the second network node 13, receiving the RA Reports may be able to forward the RA Reports to the CN. The CN may be able to forward the RA Reports to the MN connected to the SN where the one or more reports were generated. Such forwarding may potentially happen via other CN nodes connected to the MN. The MN may then forward such reports to the one or more SN node connected to it where the reports were generated.

The above mentioned assistance information may be indicating how to route the RA report because the TAI of the PCell can be used by the CN to route messages containing the RA Reports to the CN node connected to the MN. The PCell CGI includes the Global Node ID of the MN, which can be used by the CN node receiving the information to identify the MN. While The PSCell PCI and/or CGI may be used by the MN to forward the received RA Reports to the appropriate SN. With this information the MN can identify the SN to which the corresponding RA Reports need to be forwarded because the MN knows the cells served by such SN and their PCI/CGI. Assuming that the PCI of the PSCell is not reused in the neighbourhood of the PCell, the MN can identify the SN that serves the cell identified by the PSCell PCI and forward the RA Report there. Alternatively, or additionally the PSCell CGI can be used for such purpose.

In an embodiment, the UE 10 may transmit the NR RA report container upon receiving explicit indication from the network.

In a separate embodiment, the UE 10 may transmit the NR RA report container upon reception of a request to transmit a RA report related to the second access network type (LTE). In such scenario, UE transmits both LTE RACH information and NR RA report container including NR RA Report and assistance information mentioned herein.

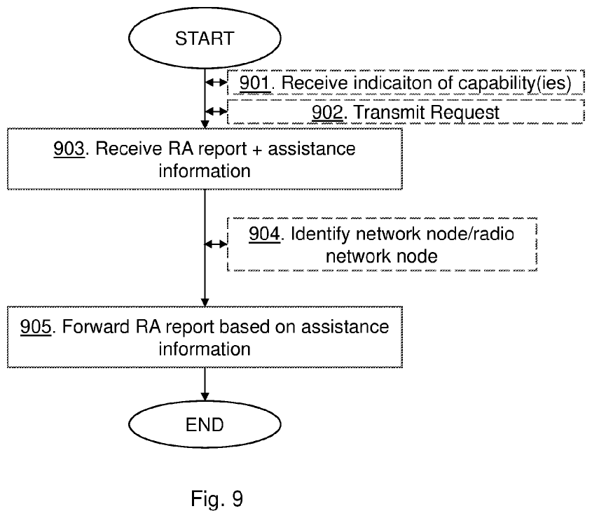

The method actions performed by the network node 150, such as the second radio network node 13 or the second network node 16 associated with the second RAT, for handling communication in the communication network 1 according to embodiments will now be described with reference to a flowchart depicted in FIG. 9. The actions do not have to be taken in the order stated below but may be taken in any suitable order. Dashed boxes indicate optional features.

Action 901. The network node 150 may receive one or more indications from the UE 10 indicating one or more capabilities comprising a capability of reporting RA reports and/or a capability to report the assistance information.

Action 902. The network node 150 may transmit the request to the UE 10 for reporting one or more RA reports. For example, the second radio network node 13 of a second RAT may request the UE 10 to provide a RA report of one or more RATs.

Action 903. The network node 150 obtains the RA report of a RA procedure of a first RAT for a UE, and assistance information indicating how to route the RA report between the second radio network node 13 of the second RAT collecting the RA report and the first radio network node 12 of the first RAT controlling the cell where the RA procedure that is logged in the RA report was performed. The network node 150 may receive the assistance information from the UE 10 or another network node.

Action 904. The network node 150 may identify one or more network nodes based on the assistance information, such as a CGI and/or TAI.

Action 905. The network node 150 forwards the RA report based on the assistance information. The assistance information indicating how to route the RA report may be defined by comprising a CGI and/or TAI of a SPCell-ID, i.e., identity of a first radio network node, for each element of a list of RA reports. Thus, the assistance information may comprise the identity of, or at least indicate, the first radio network node 12, for the received RA report.

### Network Embodiments

In one embodiment, the network node 150, such as an eNB, may receive a first indication from the UE 10 regarding capability of including the list of first report (RA Report) in the UEInformationResponse message.

In another embodiment, the network node 150 may receive a second indication from the UE 10 regarding capability of including the assistance information used to forward the RA Reports to the SN where RACH access occurred as an item in a list in the NR RA report container.

In another embodiment, the received first and second indication may be combined into a single indication.

In another embodiment, the third network node, being an example of the network node 150, e.g. eNB, which fetches, or considers fetching, the list of first report (RA Report) from the UE 10, may provide an explicit indication requesting the UE 10 to transmit the list of first report, wherein this request may optionally be an implicit request. Optionally, when determining whether to send such an explicit, and optionally implicit, request, the third network node takes into account any previously received capability indication(s) received from the UE 10 regarding the UE's capability of including the list of first report in the NR RA report container and/or the UE's capability of including the assistance information. To this end, if the third network node has not received such a capability indication, the third network node may decide not to send the explicit request requesting the UE to transmit the list of first report.

In an embodiment, upon reception of the second report from the UE 10; network identifies the nodes belonging to the second access network type from the included assistance information and forwards the first report to respective nodes. The receiving nodes forwards the list of first reports to the network nodes belonging to the first access network type as detailed in the next section.
The receiving nodes may transmit the report to all nodes of the first access network type that it has communication links available with.
The nodes belonging to the first access network type may need to forward the first report to correct node of the first access network type. Alternatively, it may drop the first report if it is not relevant to itself.

Embodiments involving routing the RA report in the network

The proposed solution involves aspects of routing of an RA report through a network, as well as signalling of capabilities concerning mechanisms for sending of an RA report from a UE. The routing aspect concerns routing of an RA report to the intended node—in the main target scenario an en-gNB—from another node—in the main target scenario an eNB—which receives the RA report from the UE 10, which previously has logged the RA information in the RA report. The capability signalling aspect concerns signalling from the UE 10, the indication to an eNB, i.e., a radio base station using LTE radio access technology, indicating a capability to deliver an RA report containing information collected in a radio base station using NR radio access technology, in the main target scenario an en-gNB, in a way that it can be appropriately treated by the receiving eNB, despite the difference in radio access technology.

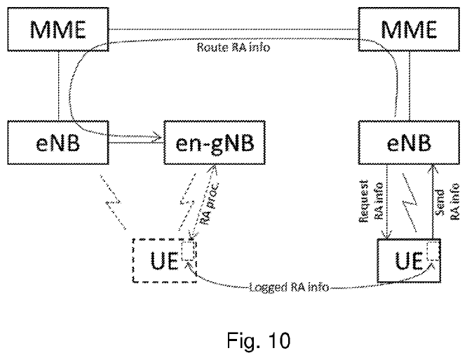

The main target scenario is illustrated in FIG. 10.

As illustrated in FIG. 10, a scenario is that a UE which is configured with EN-DC mode performs a random access procedure towards the en-gNB, i.e., the SN, logs information related to the RA procedure in an RA report, then moves and connects to another eNB, i.e., another eNB than the one that acted as the UE's MN when the RA report was logged, in the same EPC, and sends the RA report to this eNB on request from the eNB. The eNB requesting and receiving the RA report does not have any X2 connection towards the en-gNB and the eNB that acted as the UE's SN and MN respectively when the RA report was logged. It should be noted that EN-DC mode refers to a mode where the UE 10 is configured with dual connectivity towards an eNB acting as a MN and an en-gNB acting as a SN, wherein the en-gNB is operating in non-standalone mode. In this scenario, the UE 10 must send the RA report in a way, and provide such assistance information, that the network is able to route the RA report through the network to the en-gNB towards which the UE 10 performed the RA procedure when the RA information in the RA report was collected and logged.

### Routing of the RA Report.

In this section, the routing of an RA report is discussed in relation to a single RA report. However, this does not exclude that the UE 10 sends multiple RA reports, e.g., a list of RA reports, such as in the RA-ReportList-r16 IE in 3GPP TS 38.331 version 17.3.0. In such a case, the RA reports that have different destination nodes can be treated separately by the eNB receiving the RA reports.

The assistance information enabling routing of the RA report is also herein referred to as routing-enabling information.

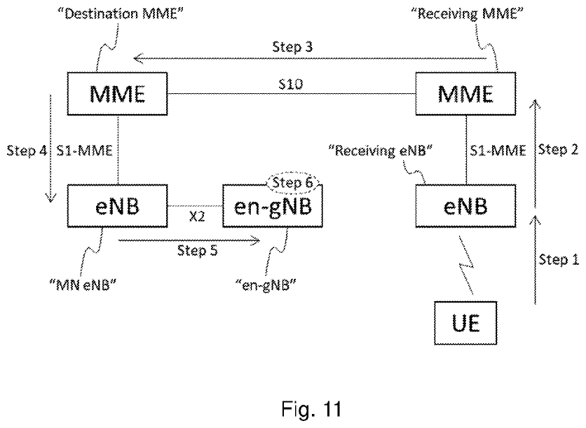

FIGS. 10 and 11 may be used as reference if it is unclear or confusing which nodes that are referred to in the description of the assistance information enabling routing of the RA report (“routing-enabling information”) below.

To enable the routing of the RA report through the network, the UE 10 provides the assistance information enabling each network node in the path to identify the next network node to forward the RA report to. Furthermore, it must also be taken into account that the eNB receiving the RA report cannot interpret the content of the RA report, since the RA report contains information in accordance with a standard specification for the NR radio access technology. And this does not only apply to the eNB receiving the RA report, but to all intermediate notes in the RA report routing, i.e. all involved nodes, except the en-gNB which is the final receiver of the RA report. Hence, all routing-enabling information must be sent from the UE separate from the RA report, but in the same UEInformationResponse RRC message as the RA report.

There is not a single set of information items that can enable the RA report routing, and hence the proposed solution includes different variants of the assistance information.

Note that in the further description of the assistance information, the information is always associated with the network nodes that were involved when the UE performed the RA procedure and logged the related information—not the network nodes involved when the UE sends the RA report to the network.

The PSCell NR Cell Global Identifier (NCGI) or the en-gNB ID can be used to enable the eNB receiving the report, herein referred to as the “receiving eNB”, to know that it is itself not the intended final receiver of the RA report, and that it does not have any X2 connection towards the final receiver of the RA report. Provided that the receiving eNB's neighbor eNBs have provided information about its NR neighbor cells, e.g., using the “NR Neighbor Information” IE in the X2 SETUP REQUEST message or ENB CONFIGURATION UPDATE message in the X2AP protocol, the PSCell NCGI also allows the receiving eNB to determine that it does not have any X2 connection towards the eNB that acted as the UE's MN when the RA report was logged. Otherwise, additional information is needed or the receiving eNB simply assumes that it has to send the received RA report to the MME it is connected to. The PSCell will thus enable the receiving eNB that it should send the received RA report to the MME it is connected to, herein referred to as the “receiving MME”, because only via CN based forwarding the RA Reports retrieved by the eNB can be forwarded to the en-gNB where they were originated.

An alternative to the PSCell NCGI or the en-gNB ID when it comes to enabling the receiving eNB to know that it should forward the RA report to the receiving MME could be the PCell NCGI or the eNB ID of the eNB that acted as the UE's MN when the RA report was logged, herein referred to as the “MN eNB”. The MN eNB ID will be useful in later routing step and this can be derived from an Evolved Cell Global Identifier (ECGI) of any of the cells served by the MN eNB, including the cell that was the UE's PCell at the time when the RA report was logged. As explained later, neither the UE 10 nor a core network node like an MME is expected to be able to derive an eNB ID from an ECGI, but RAN nodes, like eNBs are expected to be able to do so. Hence, it is more reasonable that the UE reports the PCell NCGI than the MN eNB ID, and that the receiving eNB then derives the MN eNB ID from the PCell NCGI and then forwards the RA report together with the MN eNB ID and the other routing-enabling information to the receiving MME.

The next step in the routing is enabled by the tracking area code (TAC), or TAI, associated with the Secondary cell group (SCG) cell in which the RA information was logged. This allows the receiving eNB's MME to determine the correct MME to send the RA report to, herein referred to as the “destination MME”, which in a simpler scenario can be the same MME. Note that the network can turn a TAC into a TAI by prepending the Public Land Mobile Network (PLMN) ID, which is inherently known in the network, and the TAI is what is normally used for routing between MMEs in an EPC. Optionally, the TAC (or TAI) associated with the PSCell or the TAC (or TAI) associated with the PCell may be used instead of the TAC (or TAI) associated with the SCG cell in which the RA information was logged. Typically, the TAC/TAI should be the same for all these cases, and in any case, when used for inter-MME routing, they will lead to the same MME (or MME pool).

For the next step in the routing of the RA report, i.e. from the destination MME to the MN eNB, there are several options for the RA report routing-enabling information, above also indicated as assistance information:
The eNB ID of the MN eNB. Note that even though the eNB ID of an eNB can be derived from the ECGI of any cell controlled by the eNB, e.g., the UE's PCell controlled by the MN eNB, a UE is not expected to be able to do so. Furthermore, this may be similar for an MME, since an MME is a core network node which is normally not involved with cell IDs, i.e. an MME cannot necessarily be expected to be able to derive an eNB ID from an ECGI. However, the RAN nodes are expected to know how to derive the eNB ID from an ECGI. Hence, to handle the situation, the UE 10 could log and report the PCell ECGI and the receiving eNB could derive the MN eNB ID from the PCell ECGI, and then send the MN eNB ID to the receiving MME together with the RA report and other routing-enabling information. The receiving MME could then forward the MN eNB ID and the RA report to the destination MME.
   There could still be an option that the UE 10 logs and reports the MN eNB ID, either as a UE implementation option, or as a result of newly specified requirements on UEs.
   It could also be an option to send the PCell ECGI as routing-enabling information to the destination MME, provided that the MME can actually be expected to derive the MN eNB ID from it.
The en-gNB ID, which is a gNB ID. The rationale for this is that an MME is informed of the en-gNB IDs of an eNB's (potential) connected en-gNBs in the S1 SETUP REQUEST S1AP message when the S1 interface is established, and hence, the MME can determine the eNB to route the RA report based on the en-gNB ID. As with the eNB ID, a gNB ID, which is what an en-gNB ID is, can be derived from the cell ID, i.e. from the NCGI, of any of the cells belonging to the gNB/en-gNB, but neither the UE nor an MME is expected to be able to do so. Hence, the UE 10 could report the PSCell NCGI, where the PSCell is a cell controlled by the en-gNB, and the receiving eNB could derive the en-gNB ID from the reported PSCell NCGI and then send the en-gNB ID to the receiving MME together with the RA report and other routing-enabling information. The receiving MME would then forward the en-gNB ID and the RA report to the destination MME.

For the last step of the RA report routing, i.e., from the MN eNB to the en-gNB, there are also multiple alternatives:
The NCGI of any of the SCG (PSCell) cells, i.e., an SCG cell NCGI. The MN eNB knows the NCGIs of all the cells of its connected en-gNB(s), so this enables routing of the RA report the last step to the en-gNB. The same is achieved if the MN eNB derives the en-gNB ID from the SCG cell NCGI.
The PCI of any of the SCG cells (i.e. an SCG cell PCI). There are 1008 available PCIs in NR, so with proper PCI planning, the same PCI should only appear once in all the cells of all the en-gNB(s) that might be connected to the MN eNB. Hence, an SCG cell PCI should unambiguously identify the correct SCG cell, and since the MN eNB knows the PCIs of all the cells of its connected en-gNB(s), this allows the MN eNB to forward the RA report to the correct en-gNB.
The PCI and the absolute radio-frequency channel number (ARFCN) of any of the SCG cells. A PCI is locally unique per carrier frequency (and a carrier frequency is identified by its ARFCN), so combining the closed subscriber group (CSG) cell's ARFCN with its PCI further decreases the risk for PCI collision among the cells belonging to the MN eNB and its connected en-gNB(s).
The en-gNB ID. As explained before, the UE 10 cannot be expected to be able to derive this from the NCGI. Hence, a more viable alternative would be that the UE reports an SCG cell NCGI and the receiving eNB derives the en-gNB ID from it, and then, together with the RA report, forwards the en-gNB ID to the receiving MME as part of the assistance information.
Another alternative is to not provide any assistance information at all for the last routing step. The MN eNB would then just know that it has received an RA report, which is intended for a node using, for example, NR radio access technology in its cells, but not which such node that is the intended receiver of the RA report. Based on this incomplete information, the MN eNB can send the RA report to all its connected en-gNB(s), and then each en-gNB would check the cell/d-r16 field in the RA report to find out whether it is the intended receiver of the RA report.

All the above shows how the RA report can be routed all the way to the en-gNB by means of the assistance information provided by the UE 10 together with the RA Report. Then there is one more step, which is not part of the actual RA report routing, but which may be added to provide the en-gNB to make full use of the RA report. When the en-gNB has received an RA report, it should be able to identify the cell in which the RA procedure that the RA report is associated with was performed. This information is readily included in the RA report itself in the form of the cell/d-r16 field.

Both the ECGI and the NCGI have the PLMN ID, i.e., the mobile country code (MCC)+mobile network code (MNC), in their most significant bits. This information is superfluous when the procedure is confined to a single PLMN. Hence, in all the above options where an ECGI or an NCGI is used, the PLMN ID part may be pruned from the ECGI or NCGI. This will make the information slightly more compact, with retained functionality.

After each (non-final) step of the RA report routing, the network node 150 receiving the RA report and the assistance information, can prune the part of the assistance information that is not needed for the subsequent routing step(s), before forwarding the remaining routing information together with the RA report to the next node in the routing chain.

The complete routing procedure.

The above discussion about assistance information describes how information can be provided (originating from the UE 10) to enable the network to route the RA report to be routed all the way to the en-gNB which is the intended receiver of the RA report (and to allow the en-gNB to identify the concerned cell). A complete step-by-step procedure is herein disclosed, where various messages that may be utilized to forward the RA report and the assistance information are discussed. As explained above, there are several different options for how to put together complete assistance information, i.e., which enables routing of the RA report all the way to the en-gNB and enables the en-gNB to identify the SCG cell in which the RA procedure was performed. In this step-by-step procedure example, it is assumed that the UE 10 provides the following assistance information to the receiving eNB, being an example of the network node 150:
TAC of the PCell
Pcell ECGI
PCI of the SCG cell where the RA report was logged
ARFCN of the SCG cell where the RA report was logged

FIG. 11 may be used as reference for the step-by-step example below.

FIG. 11 is a reference figure for an example step-by-step procedure according to an example.

### The Example Step-by-Step Complete RA Report Routing Procedure:

### Step 1

The UE 10 sends the RA report and the assistance information to the receiving eNB in the UEInformationResponse RRC message. The routing-enabling information is included separately from the RA report, and the RA report, being NR specific (i.e. non-LTE information), should preferably be sent as a “transparent container”, i.e. a chunk of data (e.g. OCTET STRING or BIT STRING) which the receiving eNB does not try to interpret. In the ASN.1 definition of the LTE RRC UEInformationResponse message (using 3GPP TS 38.17.3.0 as the baseline), the nonCritica/Extension option can be used to extend the message with a UEInformationResponse-v1800-IEs IE, e.g. containing the following ASN.1 code (the content of the RoutingInformation IE, which contains the routing-enabling information, should be seen as an example):

| | |
|---|---|
| en-gNB-SON-InfoTransfer-r18 | SEQUENCE { |

| | |
|---|---|
| routingInformation | RoutingInformation, |

| | |
|---|---|
| en-gNB-SON-InfoContainer | OCTET STRING -- Containing the RA report. |

...
}

| | |
|---|---|
| RoutingInformation ::= | SEQUENCE { |
| TAC | CHOICE { |
| tacOfPCell | TrackingAreaCode, -- This is a 16-bit EPS TAC. |
| tacOfPSCell | TrackingAreaCode-5GC-R15, -- This is a 24-bit 5GS |

TAC.
}

| | |
|---|---|
| pCellECGI | CellGlobalIdEUTRA, |
| pSCellInfo | SEQUENCE { |
| cellID | CHOICE { -- ID of the SCG cell in which the RA |

report was logged

| | |
|---|---|
| ncgi | CellGlobalIdNR-r16, |
| pci-arfcn | SEQUENCE { |

| | |
|---|---|
| pci | PhysCellldNR-r15, |
| arfcn | ARFCN-ValueNR-r15 |

```
      }
    }
  }
}
```

### Step 2

The eNB receiving the UEInformationResponse RRC message from the UE 10, i.e., the “receiving eNB”, extracts from the UEInformationResponse RRC message, but does not interpret, the en-gNB-SON-InfoContainerfield, which contains the RA report, and also extracts, and interprets, the parameters in the routingInformation field. The receiving eNB then derives the MN eNB ID from the PCell ECGI in the routing-enabling information. The PCell ECGI and the MN eNB ID both also tell the receiving eNB that the RA report has to be routed via the core network to reach its intended receiver.

The receiving eNB then prepares an S1AP message to send the RA report and its associated routing-enabling information to the receiving MME.

A suitable choice of S1AP message is the eNB CONFIGURATION TRANSFER message. In that message, as one possible embodiment, the receiving eNB can make use of the SON Configuration Transfer IE. In the SON Configuration Transfer IE, the receiving eNB populates the Target eNB-ID IE with the MN eNB ID (in the Global eNB ID field) and the PCell TAC prepended by the PLMN ID (in the Selected TA/field). Similarly, the receiving eNB populates the Source eNB-ID IE with its own eNB ID (in the Global eNB ID field) and a suitable TAI (in the Selected TA/field), e.g. the TAI of the cell in which the UEInformationResponse RRC message was received.

To include the RA report in the eNB CONFIGURATION TRANSFER message, the receiving eNB uses the SON Information Report IE in the SON Information IE in the SON Configuration Transfer IE. To enable this, the SON Information Report IE has to be extended with another choice alternative in the CHOICE structure. The new choice alternative could be a new IE, e.g. denoted as “En-gNB SON Information”. The “En-gNB SON Information” IE could contain the IEs “En-gNB SON Information Container” (which would be a BIT STRING), “Target PCI”, and the “Target ARFCN”. The receiving eNB includes the RA report in the En-gNB SON Information Container IE and includes in the Target PC/and ARFCN IEs the PCI and ARFCN of the SCG cell where the RA report was logged.

Finally, the receiving eNB sends the eNB CONFIGURATION TRANSFER S1AP message to the receiving MME.

### Step 3

The receiving MME uses the TAI in the Selected TA/IE in the Target eNB-ID IE in the received eNB CONFIGURATION TRANSFER S1AP message to identify the MME to forward selected information to, i.e. the destination MME, and uses legacy mechanisms to transparently forward the SON Configuration Transfer IE.

### Step 4

The destination MME uses the MN eNB ID (which was included in the Global eNB ID IE in the Target eNB-ID IE in the SON Configuration Transfer IE, and possibly also included otherwise in the inter-MME message) to identify the eNB to forward information to, and forwards the SON Configuration Transfer IE to the MN eNB in an MME CONFIGURATION TRANSFER S1AP message.

### Step 5

The MN eNB extracts the RA report and the PCI and ARFCN of the SCG cell where the RA report was logged from the En-gNB SON Information IE (which is included in the SON Information Report IE which is included in the SON Information IE which is included in the SON Configuration Transfer IE).

The MN eNB uses the PCI and (if needed) ARFCN of the SCG cell where the RA report was logged to identify the en-gNB that is the intended receiver of the RA report. The MN eNB then forwards the RA report to the identified en-gNB. To do this, the MN eNB may, as one alternative, use the EN-DC CONFIGURATION TRANSFER X2AP message. In this X2AP message, RA report could be included in a new IE, as one alternative, or in the EN-DC SON Configuration Transfer IE, as another alternative. As another alternative, the MN eNB may use a newly specified X2AP message, e.g. denoted as “SON INFORMATION TRANSFER” to send the RA report to the en-gNB. As further options, the MN eNB may forward the entire received SON Configuration Transfer IE (or at least the content thereof) to the en-gNB, either in a new IE in the EN-DC CONFIGURATION TRANSFER X2AP message, or in a new IE in a new X2AP message (e.g. denoted as above, i.e. “SON INFORMATION TRANSFER”).

### Step 6

This step is not part of the actual routing of the RA report. In this step the en-gNB reads the information in the received RA report, identifies the cell in which the RA report was logged, based on the cellId-r16 field in the RA report (i.e. in the RA-Report-r16 IE), and optionally adds the RA report information to the information forming the basis for potential optimizations of configurations in the concerned cell, e.g. changes of the RACH related configuration.

### Another RA Report Routing Example in Brief:

In another routing example, if the UE includes the NCGI (instead of the PCI and ARFCN) of the SCG cell where the RA report was logged in the routing-enabling information (e.g. in the routingInformation IE), the receiving eNB uses this NCGI to derive the en-gNB ID. Together with the other received routing-enabling information, and information that the receiving eNB inherently knows (e.g. from its own configuration parameters), this enables the receiving eNB to use the EN-DC SON Configuration Transfer IE (which also contains the SON Information IE) to convey the RA report to the receiving MME. The EN-DC SON Configuration Transfer IE can then be forwarded all the way to the en-gNB. To enable this, the EN-DC SON Configuration Transfer IE may possibly have to be extended with an additional Transfer Type choice alternative (in addition to the choice alternatives Request and Reply), which is neither a request nor a reply, but an unsolicited report, e.g. denoted as Report.

### Other RA Report Routing Scenarios

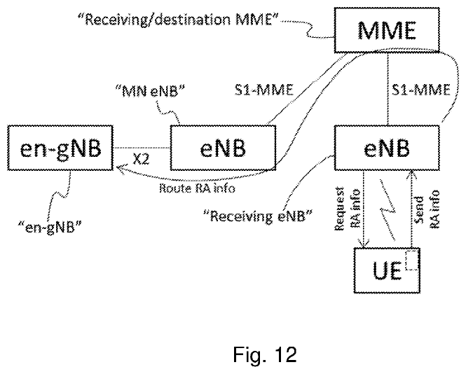

The main target scenario for which the solution has been described above is the most extensive one. This is good for the purpose of description of the solution, since it allows a comprehensive coverage of the various aspects and steps of the solution. However, simpler scenarios for the RA report routing may be more frequently occurring and are thus also of interest. FIGS. 12, 13 and 14 illustrate a few such RA report routing scenarios.

FIG. 12 shows a RA report routing scenario with a single MME, i.e., no inter-MME routing.

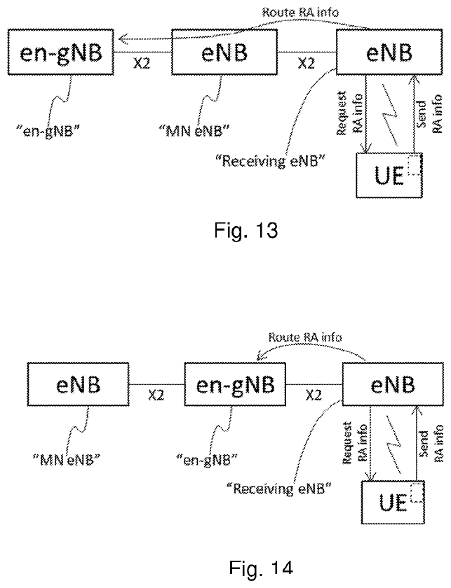

FIG. 13 shows a RA report routing scenario with X2 connection between the receiving eNB and the MN eNB.

FIG. 14 shows a RA report routing scenario with X2 connection between the receiving eNB and the SN eNB.

The above simpler RA report routing scenarios contains fewer routing hops than the more comprehensive main target scenario. Hence, not all the assistance information described for the main target scenario is needed in these scenarios. For each of these simpler RA report routing scenarios, only a certain subset of the assistance information parameters is needed. Optionally, the UE 10 may omit unnecessary parameters in the routing-enabling information (e.g. in the RoutingInformation IE), provided that the UE 10 can deduce the structure/topology of the RA report routing path, e.g., the number of routing hops and the involved types of nodes. As another option, the receiving eNB may discard unnecessary parameters in the assistance information, i.e., routing-enabling information, received from the UE 10 and omit the corresponding parameters in the assistance information sent to the next-hop node.

### Impact on TS 36.331

An example implementation in TS 36.331 is provided where UE receives explicit indication from the network to transmit the list of first reports—

### 5.6.5.3 Reception of the UEInformationRequest Message

Upon receiving the UEInformationRequest message, the UE shall, only after successful security activation:
1> if rach-ReportReq is set to true, set the contents of the rach-Report in the UEInformationResponse message as follows:
   2> set the numberOfPreamblesSent to indicate the number of preambles sent by MAC for the last successfully completed random access procedure;
   2> if contention resolution was not successful as specified in TS 36.321 [6] for at least one of the transmitted preambles for the last successfully completed random access procedure:
      3> set the contentionDetected to true;
   2> else:
      3> set the contentionDetected to false;
   2> if the UE is a BL UE or UE in CE:
      3> set the initialCEL to indicate the initial CE level used for the last successfully completed random access procedure;
   2> if the UE is a NB-IoT UE:
      3> set the initialNRSRP-Level to indicate the NRSRP level of the NPRACH resource selected for the first preamble transmission for the last successfully completed random access procedure;
   2> if the UE is a BL UE, UE in CE or NB-IoT UE:
      3> if the last successfully completed random access procedure was initiated with EDT PRACH resource and succeeded after receiving EDT fallback indication from lower layers:
         4> set the edt-Fallback to true;
      3> else:
         4> set the edt-Fallback to false;
1> if nr-rach-ReportReg is set to true, and the UE has random access related information in VarRA-Report as defined in TS 38.331
   3> set the RA-ReportList in UEInformationResponse message with the value of ra-ReportList in VarRA-Report.
   3> set each element of CellIdList with the CGI of the spCellID from each element of the ra-ReportList.
   3> discard the ra-ReportList from VarRA-Report upon successful delivery of the UEInformationResponse message confirmed by lower layers:
1> if rlf-ReportReq is set to true and the UE has radio link failure information or handover failure information available in VarRLF-Report (VarRLF-Report-NB in NB-IoT) and if the RPLMN is included in plmn-IdentityList stored in VarRLF-Report:
   2> for NB-IoT, if the global cell identity of the selected cell is the same as the reestablishmentCellId in the VarRLF-Report-NB:
      3> remove the reestablishmentCellId from the VarRLF-Report-NB;
   2> set timeSinceFailure in VarRLF-Report (VarRLF-Report-NB in NB-IoT) to the time that elapsed since the last radio link or handover failure in E-UTRA;
   2> set the rlf-Report in the UEInformationResponse message to the value of rlf-Report in VarRLF-Report (VarRLF-Report-NB in NB-IoT);
   2> discard the rlf-Report from VarRLF-Report (VarRLF-Report-NB in NB-IoT) upon successful delivery of the UEInformationResponse message confirmed by lower layers;
1> except for NB-IoT, if connEstFailReportReq is set to true and the UE has connection establishment failure information in VarConnEstFailReport and if the RPLMN is equal to plmn-Identity stored in VarConnEstFailReport:
   2> set timeSinceFailure in VarConnEstFailReport to the time that elapsed since the last connection establishment failure in E-UTRA;
   2> set the connEstFailReport in the UEInformationResponse message to the value of connEstFailReport in VarConnEstFailReport;
   2> discard the connEstFailReport from VarConnEstFailReport upon successful delivery of the UEInformationResponse message confirmed by lower layers;
1> except for NB-IoT, if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRef and set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if logMeasResultListBT is included in one or more of the additional logged measurement entries in VarLogMeasReport that are not included in the logMeasInfoList within the UEInformationResponse message:
         5> include the logMeasAvailableBT;
         4> if logMeasResultListWLAN is included in one or more of the additional logged measurement entries in VarLogMeasReport that are not included in the logMeasInfoList within the UEInformationResponse message:
         5> include the logMeasAvailableWLAN;
1> except for NB-IoT, if mobilityHistoryReportReq is set to true:
   2> include the mobilityHistoryReport and set it to include entries from VarMobilityHistoryReport;
   2> include in the mobilityHistoryReport an entry for the current cell, possibly after removing the oldest entry if required, and set its fields as follows:
      3> set visitedCellId to the global cell identity or the physical cell identity and carrier frequency of the current cell:
      3> set field timeSpent to the time spent in the current cell;
1> except for NB-IoT, if the idleModeMeasurementReq is included in the UEInformationRequest and the UE has stored VarMeasIdleReport that contains measurement information concerning cells other than the PCell:
   2> set the measResultListIdle-r15 in the UEInformationResponse message to the value of measReportIdle-r15 in the VarMeasIdleReport;
   2> set the measResultListExtIdle in the UEInformationResponse message to the value of measReportIdle-r16 in the VarMeasIdleReport, if available;
   2> set the measResultListIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> except for NB-IoT, ifflightPathInfoReq field is present and the UE has flight path information available:
   2> include the flightPathInfoReport and set it to include the list of waypoints along the flight path;
   2> if the includeTimeStamp is set to TRUE:
      3> set the field timeStamp to the time when UE intends to arrive to each waypoint if this information is available at the UE;
1> for NB-IoT, if anr-ReportReq is set to true and the UE has measResultList available in VarANR-MeasReport-NB:
   2> set the anr-MeasReport in the UEInformationResponse message as follows:
      3> if the global cell identity of the PCell is different from servCellIdentity in the VarANR-MeasReport-NB;
         4> include the servCellIdentity and set it to the value of servCellIdentity in the VarANR-MeasReport-NB;
      3> set measResultServCell to the value of measResultServCell in the VarANR-MeasReport-NB;
      3> set relativeTimeStamp to the value of relativeTimeStamp in the VarANR-MeasReport-NB;
      3> set measResultList to the value of measResultList in the VarANR-MeasReport-NB;
   2> discard the VarANR-MeasReport-NB upon successful delivery of the UEInformationResponse message confirmed by lower layers;
1> except for NB-IoT, if the coarseLocationReq is set to true:
   2> if available, include the coarseLocationInfo;
1> if the logMeasReport is included in the UEInformationResponse:
   2> submit the UEInformationResponse message to lower layers for transmission via SRB2;
   2> discard the logged measurement entries included in the logMeasInfoList from VarLogMeasReport upon successful delivery of the UEInformationResponse message confirmed by lower layers;
1> else:
   2> submit the UEInformationResponse message to lower layers for transmission via SRB1;

An example implementation in TS 36.331 is provided where UE does not receive any explicit indication from the network to transmit the list of first reports—

### 1 5.6.5.3 Reception of the UEInformationRequest Message

Upon receiving the UEInformationRequest message, the UE shall, only after successful security activation:
1> if rach-ReportReq is set to true, set the contents of the rach-Report in the UEInformationResponse message as follows:
   2> set the numberOfPreamblesSent to indicate the number of preambles sent by MAC for the last successfully completed random access procedure;
   2> if contention resolution was not successful as specified in TS 36.321 [6] for at least one of the transmitted preambles for the last successfully completed random access procedure:
      3> set the contentionDetected to true;
   2> else:
      3> set the contentionDetected to false;
   2> if the UE is a BL UE or UE in CE:
      3> set the initialCEL to indicate the initial CE level used for the last successfully completed random access procedure;
   2> if the UE is a NB-IoT UE:
      3> set the initialNRSRP-Level to indicate the NRSRP level of the NPRACH resource selected for the first preamble transmission for the last successfully completed random access procedure;
   2> if the UE is a BL UE, UE in CE or NB-IoT UE:
      3> if the last successfully completed random access procedure was initiated with EDT PRACH resource and succeeded after receiving EDT fallback indication from lower layers:
         4> set the edt-Fallback to true;
      3> else:
         4> set the edt-Fallback to false;
   2> if the UE supports NR RACH reporting and has random access related information in VarRA-Report as defined in TS 38.331
      3> set the RA-ReportList in UEInformationResponse message with the value of ra-ReportList in VarRA-Report.
      3> set each element of CellIdList with the CGI of the spCellID from each element of the ra-ReportList.
      3> discard the ra-ReportList from VarRA-Report upon successful delivery of the UEInformationResponse message confirmed by lower layers:
1> if rlf-ReportReq is set to true and the UE has radio link failure information or handover failure information available in VarRLF-Report (VarRLF-Report-NB in NB-IoT) and if the RPLMN is included in plmn-IdentityList stored in VarRLF-Report:
   2> for NB-IoT, if the global cell identity of the selected cell is the same as the reestablishmentCellId in the VarRLF-Report-NB:
      3> remove the reestablishmentCellId from the VarRLF-Report-NB;
   2> set timeSinceFailure in VarRLF-Report (VarRLF-Report-NB in NB-IoT) to the time that elapsed since the last radio link or handover failure in E-UTRA;
   2> set the rlf-Report in the UEInformationResponse message to the value of rlf-Report in VarRLF-Report (VarRLF-Report-NB in NB-IoT);
   2> discard the rlf-Report from VarRLF-Report (VarRLF-Report-NB in NB-IoT) upon successful delivery of the UEInformationResponse message confirmed by lower layers;
1> except for NB-IoT, if connEstFailReportReq is set to true and the UE has connection establishment failure information in VarConnEstFailReport and if the RPLMN is equal to plmn-Identity stored in VarConnEstFailReport:
   2> set timeSinceFailure in VarConnEstFailReport to the time that elapsed since the last connection establishment failure in E-UTRA;
   2> set the connEstFailReport in the UEInformationResponse message to the value of connEstFailReport in VarConnEstFailReport;
   2> discard the connEstFailReport from VarConnEstFailReport upon successful delivery of the UEInformationResponse message confirmed by lower layers;
1> except for NB-IoT, if the logMeasReportReq is present and if the RPLMN is included in plmn-IdentityList stored in VarLogMeasReport:
   2> if VarLogMeasReport includes one or more logged measurement entries, set the contents of the logMeasReport in the UEInformationResponse message as follows:
      3> include the absoluteTimeStamp and set it to the value of absoluteTimeInfo in the VarLogMeasReport;
      3> include the traceReference and set it to the value of traceReference in the VarLogMeasReport;
      3> include the traceRecordingSessionRefand set it to the value of traceRecordingSessionRef in the VarLogMeasReport;
      3> include the tce-Id and set it to the value of tce-Id in the VarLogMeasReport;
      3> include the logMeasInfoList and set it to include one or more entries from the VarLogMeasReport starting from the entries logged first, and for each entry of the logMeasInfoList that is included, include all information stored in the corresponding logMeasInfoList entry in VarLogMeasReport;
      3> if the VarLogMeasReport includes one or more additional logged measurement entries that are not included in the logMeasInfoList within the UEInformationResponse message:
         4> include the logMeasAvailable;
         4> if logMeasResultListBT is included in one or more of the additional logged measurement entries in VarLogMeasReport that are not included in the logMeasInfoList within the UEInformationResponse message:
         5> include the logMeasAvailableBT;
         4> if logMeasResultListWLAN is included in one or more of the additional logged measurement entries in VarLogMeasReport that are not included in the logMeasInfoList within the UEInformationResponse message:
         5> include the logMeasAvailableWLAN;
1> except for NB-IoT, if mobilityHistoryReportReq is set to true:
   2> include the mobilityHistoryReport and set it to include entries from VarMobilityHistoryReport;
   2> include in the mobilityHistoryReport an entry for the current cell, possibly after removing the oldest entry if required, and set its fields as follows:
      3> set visitedCellId to the global cell identity or the physical cell identity and carrier frequency of the current cell:
      3> set field timeSpent to the time spent in the current cell;
1> except for NB-IoT, if the idleModeMeasurementReq is included in the UEInformationRequest and the UE has stored VarMeasIdleReport that contains measurement information concerning cells other than the PCell:
   2> set the measResultListIdle-r15 in the UEInformationResponse message to the value of measReportIdle-r15 in the VarMeasIdleReport;
   2> set the measResultListExtIdle in the UEInformationResponse message to the value of measReportIdle-r16 in the VarMeasIdleReport, if available;
   2> set the measResultListIdleNR in the UEInformationResponse message to the value of measReportIdleNR in the VarMeasIdleReport, if available;
   2> discard the VarMeasIdleReport upon successful delivery of the UEInformationResponse message confirmed by lower layers;
1> except for NB-IoT, ifflightPathInfoReq field is present and the UE has flight path information available:
   2> include the flightPathInfoReport and set it to include the list of waypoints along the flight path;
   2> if the includeTimeStamp is set to TRUE:
      3> set the field timeStamp to the time when UE intends to arrive to each waypoint if this information is available at the UE;
1> for NB-IoT, if anr-ReportReq is set to true and the UE has measResultList available in VarANR-MeasReport-NB:
   2> set the anr-MeasReport in the UEInformationResponse message as follows:
      3> if the global cell identity of the PCell is different from servCellIdentity in the VarANR-MeasReport-NB;
         4> include the servCellIdentity and set it to the value of servCellIdentity in the VarANR-MeasReport-NB;
      3> set measResultServCell to the value of measResultServCell in the VarANR-MeasReport-NB;
      3> set relativeTimeStamp to the value of relativeTimeStamp in the VarANR-MeasReport-NB;
      3> set measResultList to the value of measResultList in the VarANR-MeasReport-NB;
   2> discard the VarANR-MeasReport-NB upon successful delivery of the UEInformationResponse message confirmed by lower layers;
1> except for NB-IoT, if the coarseLocationReq is set to true:
   2> if available, include the coarseLocationInfo;
1> if the logMeasReport is included in the UEInformationResponse:
   2> submit the UEInformationResponse message to lower layers for transmission via SRB2;
   2> discard the logged measurement entries included in the logMeasInfoList from VarLogMeasReport upon successful delivery of the UEInformationResponse message confirmed by lower layers;
1> else:
   2> submit the UEInformationResponse message to lower layers for transmission via SRB1;

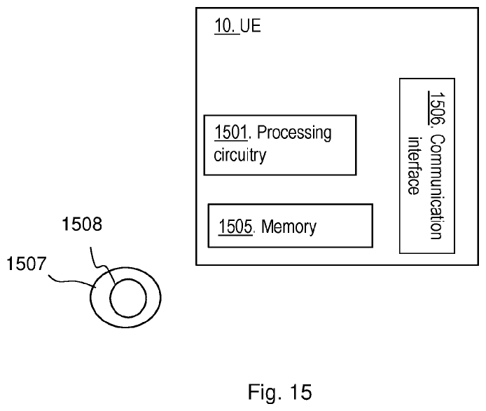

FIG. 15 shows a block diagram depicting the UE 10 for handling communication in the communication network 1 according to embodiments herein.

The UE 10 may comprise processing circuitry 1501, e.g., one or more processors, configured to perform the methods herein.

The UE 10 and/or the processing circuitry 1501 may be configured to obtain RA parameters of a RA procedure and may store RA reports associated with assistance information.

The UE 10 and/or the processing circuitry 1501 may be configured to indicate to the second radio network node 13 one or more capabilities comprising a capability of reporting RA reports and/or a capability to report the assistance information.

The UE 10 and/or the processing circuitry 1501 may be configured to receive a request from the second radio network node 13 for reporting one or more RA reports. The UE 10 may receive a request from a second radio network node (LTE eNB) of a second RAT (LTE) to provide a RA report.

The UE 10 and/or the processing circuitry 1501 is configured to provide to the network node 150 a RA report of a RA procedure over a first RAT for the UE 10, and assistance information indicating how to route the RA report between the second radio network node 13 of the second RAT collecting the RA report and the first radio network node 12 of the first RAT controlling the cell where the RA procedure that is logged in the RA report was performed. The assistance information indicating how to route the RA report may be defined by comprising the CGI and/or the TAI of the SPCell-ID for each element of a list of RA reports.

The UE 10 may comprise a memory 1505. The memory 1505 comprises one or more units to be used to store data on, such as data packets, RA reports, lists, assistance information, indications, thresholds, signal strengths/qualities, measurements, RA procedures, events and applications to perform the methods disclosed herein when being executed, and similar. Furthermore, the UE 10 may comprise a communication interface 1506 such as comprising a transmitter, a receiver, a transceiver and/or one or more antennas.

The methods according to the embodiments described herein for the UE 10 are respectively implemented by means of e.g. a computer program product 1507 or a computer program, comprising instructions, i.e., software code portions, which, when executed on at least one processor, cause the at least one processor to carry out the actions described herein, as performed by the UE 10. The computer program product 1507 may be stored on a computer-readable storage medium 1508, e.g. a disc, a universal serial bus (USB) stick or similar. The computer-readable storage medium 1508, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for handling communication in a communication network, wherein the UE 10 comprises processing circuitry and a memory, said memory comprising instructions executable by said processing circuitry whereby said UE 10 is operative to perform any of the methods herein.

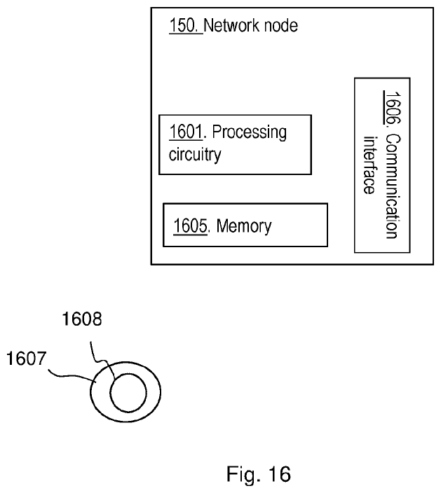

FIG. 16 shows a block diagram depicting the network node 150, such as the second radio network node 13 or the second network node 16 associated with the second RAT, for handling communication in the communication network 1 according to embodiments herein.

The network node 150 may comprise processing circuitry 1601, e.g., one or more processors, configured to perform the methods herein.

The network node 150 and/or the processing circuitry 1601 is configured to obtain, i.e., receive, the RA report of the RA procedure of the first RAT for the UE 10, and the assistance information indicating how to route the RA report between the second radio network node 13 of the second RAT collecting the RA report and the first radio network node 12 of the first RAT controlling the cell where the RA procedure that is logged in the RA report was performed.

The network node 150 and/or the processing circuitry 1601 is configured to forward the RA report based on the assistance information.

The network node 150 and/or the processing circuitry 1601 may be configured to receive the one or more indications from the UE 10 indicating the one or more capabilities such as the capability of reporting RA reports and/or the capability to report the assistance information.

The network node 150 and/or the processing circuitry may be configured to transmit the request to the UE 10 for reporting one or more RA reports.

The network node 150 and/or the processing circuitry may be configured to identify the one or more network nodes based on the assistance information.

The assistance information indicating how to route the RA report may be defined by comprising a CGI and/or TAI of a SPCell-ID, i.e., identity of a first radio network node, for each element of a list of RA reports. Thus, the assistance information may comprise the identity of the first radio network node 12, for the received RA report.

The network node 150 may comprise a memory 1605. The memory 1605 comprises one or more units to be used to store data on, such as data packets, indications, identities of network nodes, route information, RA configurations, allocated resources, thresholds, events and applications to perform the methods disclosed herein when being executed, and similar. Furthermore, the network node 150 may comprise a communication interface 1606 such as comprising a transmitter, a receiver, a transceiver and/or one or more antennas.

The methods according to the embodiments described herein for the network node 150 are respectively implemented by means of e.g. a computer program product 1607 or a computer program, comprising instructions, i.e., software code portions, which, when executed on at least one processor, cause the at least one processor to carry out the actions described herein, as performed by the network node. The computer program product 1607 may be stored on a computer-readable storage medium 1608, e.g. a disc, a USB stick or similar. The computer-readable storage medium 1608, having stored thereon the computer program product, may comprise the instructions which, when executed on at least one processor, cause the at least one processor to carry out the actions described herein, as performed by the network node. In some embodiments, the computer-readable storage medium may be a transitory or a non-transitory computer-readable storage medium. Thus, embodiments herein may disclose a network node for handling communication in a communication network, wherein the network node comprises processing circuitry and a memory, said memory comprising instructions executable by said processing circuitry whereby said network node is operative to perform any of the methods herein.

In some embodiments a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or UE is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, IoT capable device, smart phone, laptop embedded equipped (LEE), laptop mounted equipment (LME), USB dongles etc.

Embodiments are applicable to any RAT or multi-RAT systems, where the UE receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

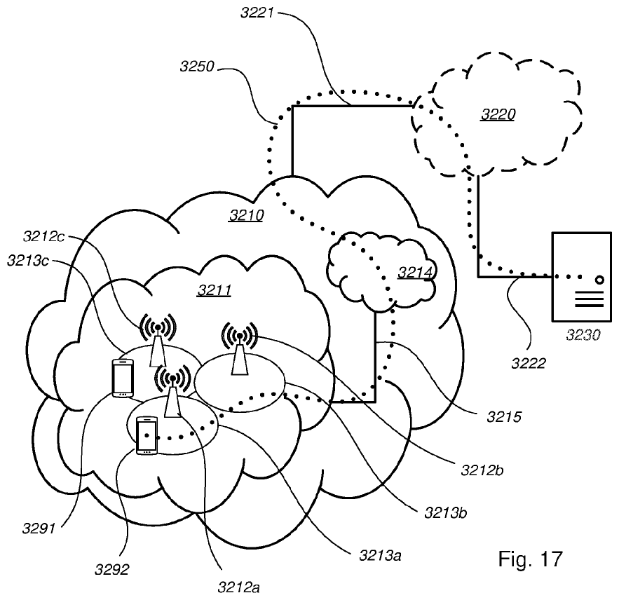

With reference to FIG. 17, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 17 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

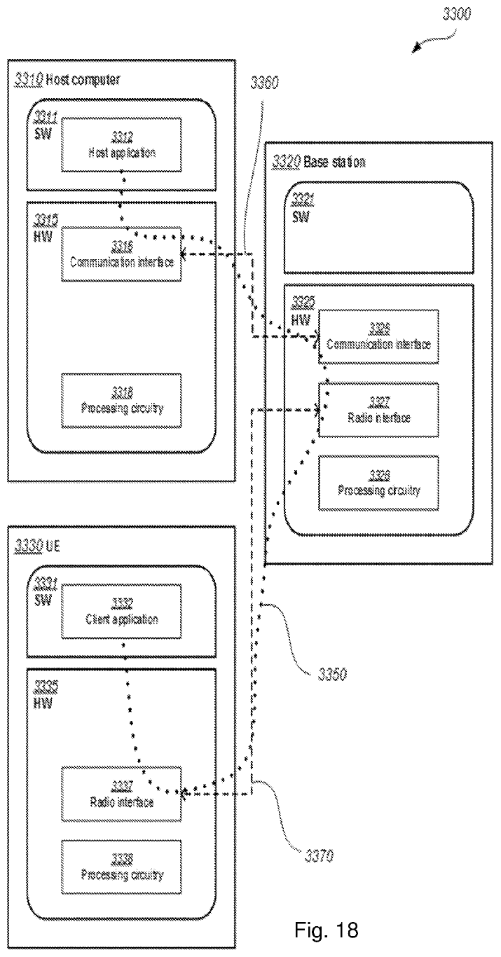

Example implementations, in accordance with an embodiment, of the UE, base station and host computer discussed in the preceding paragraphs will now be described with reference to FIG. 18. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 18) served by the base station 3320. The communication interface 3326 may be configured to facilitate a connection 3360 to the host computer 3310. The connection 3360 may be direct or it may pass through a core network (not shown in FIG. 18) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 18 may be identical to the host computer 3230, one of the base stations 3212a, 3212b, 3212c and one of the UEs 3291, 3292 of FIG. 17, respectively. This is to say, the inner workings of these entities may be as shown in FIG. 18 and independently, the surrounding network topology may be that of FIG. 17.

In FIG. 18, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since RA reports reach correct network node in an efficient manner and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

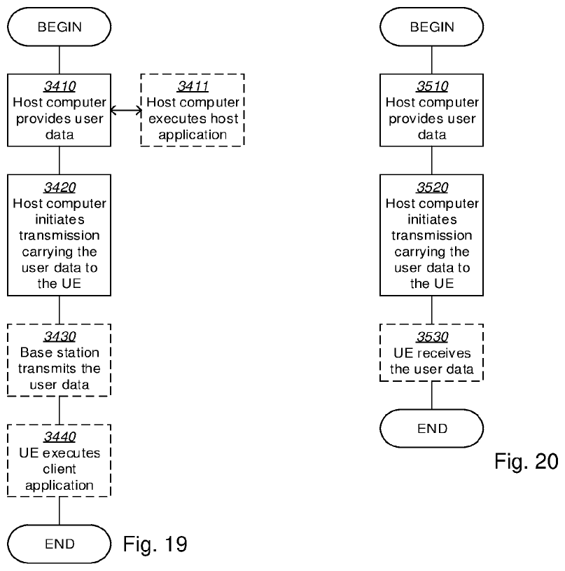

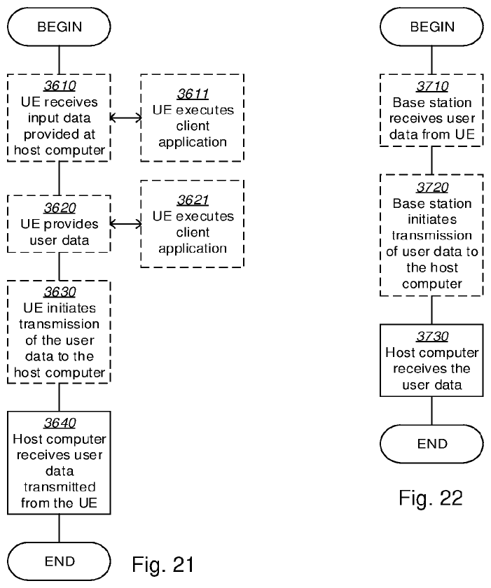

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 19 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### EMBODIMENTS

### Embodiment A1

A method performed by a UE for handling communication in a communication network, the method comprising
providing to a network node a RA report of a RA procedure over a first RAT for the UE, and assistance information indicating how to route the RA report between a second radio network node of a second RAT collecting the RA report and a first radio network node of the first RAT controlling a cell where the RA procedure that is logged in the RA report was performed.

### Embodiment A2

The method according to embodiment A1, further comprising
indicating to the second radio network node one or more capabilities such as reporting RA reports and/or a capability to report the assistance information.

### Embodiment A3

The method according to any of the embodiments A1-A2, further comprising
storing obtained one or more RA reports associated with one or more assistance information.

### Embodiment A4

The method according to any of the embodiments A1-A3, wherein the assistance information comprises a CGI of a SPCell-ID, i.e., identity of a first radio network node, for each element of a list of RA reports.

### Embodiment E1

A method performed by a the network node, such as the second radio network node 13 or the second network node 16 associated with a second RAT, for handling communication in a communication network, the method comprising
obtaining a RA report of a RA procedure of a first RAT for a UE, and assistance information indicating how to route the RA report between a second radio network node of a second RAT collecting the RA report and the first radio network node controlling the cell where the RA procedure that is logged in the RA report was performed; and
forwarding the RA report based on the assistance information.

### Embodiment B2

The method according to embodiment E1, further comprising
receiving one or more indications from the UE indicating one or more capabilities such as capability of reporting RA reports and/or a capability to report the assistance information.

### Embodiment B3

The method according to any of the embodiments B1-B2, further comprising
transmitting a request to the UE for reporting one or more RA reports.

### Embodiment B4

The method according to any of the embodiments B1-B3, further comprising
identifying one or more network nodes based on the assistance information.

### Embodiment B5

The method according to any of the embodiments B1-B4, wherein the assistance information comprises a CGI of a SPCell-ID, i.e., identity of a first radio network node, for each element of a list of RA reports.

### Embodiment C1

A UE for handling communication in a communication network, wherein the UE is configured to
provide to a network node a RA report of a RA procedure over a first RAT for the UE, and assistance information indicating how to route the RA report between a second radio network node of a second RAT collecting the RA report and a first radio network node of the first RAT controlling a cell where the RA procedure that is logged in the RA report was performed.

### Embodiment D1

A network node, such as the second radio network node 13 or the second network node 16 associated with a second RAT, for handling communication in a communication network, wherein the network node is configured to
obtain a RA report of a RA procedure of a first RAT for a UE, and assistance information indicating how to route the RA report between a second radio network node of a second RAT collecting the RA report and the first radio network node controlling the cell where the RA procedure that is logged in the RA report was performed; and
forward the RA report based on the assistance information.

### Abbreviation Explanation

RA Random Access
MN Master Node
SN Secondary Node
DC Dual Connectivity
MME Mobility Management Entity
AMF Access and Mobility Management Function
CGI Cell Global Identity
PCell Primary Cell
PSCell Primary Secondary Cell
CN Core Network
RAN Radio Access Network
NCGI NR Cell Global Identifier
ECGI Evolved Cell Global Identifier

### REFERENCES

[1] 37.340; Evolved Universal Terrestrial Radio Access (E-UTRA) and NR; Multi-Connectivity; Stage 2-V17.3.0, 3GPP
[2] 38.331; NR; Radio Resource Control (RRC); Protocol specification; V-17.3.0, 3GPP
[3] R2-2211164, Reply LS on SN RACH report status in R17, 3GPP TSG RAN WG #120

1. A method performed by a user equipment, UE, for handling communication in a communication network, the method comprising:
providing to a network node, a random access, RA, report of a RA procedure over a first radio access technology, RAT, for the UE, and assistance information indicating how to route the RA report between a second radio network node of a second RAT collecting the RA report and a first radio network node of the first RAT controlling a cell where the RA procedure that is logged in the RA report was performed.

2. The method according to claim 1, further comprising:
indicating to the second radio network node one or more capabilities comprising one or both of a capability of reporting RA reports and a capability to report the assistance information.

3. The method according to claim 1, further comprising:
storing obtained one or more RA reports associated with one or more assistance information.

4. The method according to claim 1, wherein the assistance information indicating how to route the RA report is defined by comprising one or both of a cell global identity, CGI, and tracking area identifier, TAI, of a special cell, SPCell, identity for each element of a list of RA reports.

5. A method performed by a network node for handling communication in a communication network, the method comprising:
obtaining a random access, RA, report of a RA procedure of a first radio access technology, RAT, for a user equipment, UE, and assistance information indicating how to route the RA report between a second radio network node of a second RAT collecting the RA report and the first radio network node of the first RAT controlling a cell, where the RA procedure that is logged in the RA report was performed; and
forwarding the RA report based on the assistance information.

6. The method according to claim 5, further comprising:
receiving one or more indications from the UE indicating one or more capabilities comprising one or both of a capability of reporting RA reports and a capability to report the assistance information.

7. The method according to claim 5, further comprising:
transmitting a request to the UE for reporting one or more RA reports.

8. The method according to claim 5, further comprising:
identifying one or more network nodes based on the assistance information.

9. The method according to claim 5, wherein the assistance information indicating how to route the RA report is defined by comprising one or both of a cell global identity, CGI, and tracking area identifier, TAI, of a special cell, SPCell, identity for each element of a list of RA reports.

10. A user equipment, UE, for handling communication in a communication network, the UE comprising processing circuitry and a memory, the memory comprising instructions executable by the processing circuitry to configure the UE to:
provide to a network node a random access, RA, report of a RA procedure over a first radio access technology, RAT, for the UE, and assistance information indicating how to route the RA report between a second radio network node of a second RAT collecting the RA report and a first radio network node of the first RAT controlling a cell where the RA procedure that is logged in the RA report was performed.

11. The UE according to claim 10, wherein the UE is further configured to:
indicate to the second radio network node one or more capabilities comprising one or both of a capability of reporting RA reports and a capability to report the assistance information.

12. The UE according to claim 10, wherein the UE is further configured to:
store obtained one or more RA reports associated with one or more assistance information.

13. The UE according to claim 10, wherein the assistance information indicating how to route the RA report is defined by comprising one or both of a cell global identity, CGI, and tracking area identifier, TAI, of a special cell, SPCell, identity for each element of a list of RA reports.

14.-22. (canceled)

23. The method according to claim 2, further comprising:
storing obtained one or more RA reports associated with one or more assistance information.

24. The method according to claim 2, wherein the assistance information indicating how to route the RA report is defined by comprising one or both of a cell global identity, CGI, and tracking area identifier, TAI, of a special cell, SPCell, identity for each element of a list of RA reports.

25. The method according to claim 6, further comprising:
transmitting a request to the UE for reporting one or more RA reports.

26. The method according to claim 6, further comprising:
identifying one or more network nodes based on the assistance information.

27. The method according to claim 6, wherein the assistance information indicating how to route the RA report is defined by comprising one or both of a cell global identity, CGI, and tracking area identifier, TAI, of a special cell, SPCell, identity for each element of a list of RA reports.

28. The UE according to claim 11, wherein the UE is further configured to:
store obtained one or more RA reports associated with one or more assistance information.

29. The UE according to claim 11, wherein the assistance information indicating how to route the RA report is defined by comprising one or both of a cell global identity, CGI, and tracking area identifier, TAI, of a special cell, SPCell, identity for each element of a list of RA reports.
